(19) United States
(12) Patent Application Publication
(10) Pub. No.: US 2006/0121251 A1
(43) Pub. Date: Jun. 8, 2006

(54) Method for production of an object and object produced by said method

(75) Inventors: Peter Oberacher, Holzkirchen (DE); Matthias Sprotte, Ona (CH); Frank Ehrig, Jona (CH)

Correspondence Address: SUGHRUE MION, PLLC, 2100 PENNSYLVANIA AVENUE, N.W., SUITE 800, WASHINGTON, DC, 20037, US

(73) Assignee: Weidmann Plastics Technology AG

(21) Appl. No.: 10/518,794

(22) PCT Filed: Jun. 23, 2003
(86) PCT No.: PCT/CH03/00404

§ 371 Date: Jul. 28, 2005

(30) Foreign Application Priority Data
Jun. 21, 2002 (CH) 1068/02

(51) Int. Cl. B29C 45/14; B29C 59/00; B32B 3/00

(52) U.S. Cl. 428/172; 264/265; 264/266; 264/293; 428/173

(57) ABSTRACT

The object (10, 10′) comprises a first layer (1), for example with a back injection of a second layer (2), whereby the first layer is plastically deformable and comprises a front face (1a) and a rear face (1b). The back injection of the first layer (1) takes place in an injection mould. Before the back injection, the first layer (1) is partly provided with a coating (4′) on the front face (1a) thereof and said coating is hardened. The first layer (1) is then placed in an injection mould (6). The first layer (1) is then back injected in the injection mould (6), thus forming the second layer (2), such that the first layer (1) is pressed with the front face (1a) thereof on an inner side (7) of the injection mould (6) and the hardened coating (4′) on the first layer (1) is deformed and at least partly pressed into the first layer (1). The coating (4′) is preferably applied by printing, for example by means of a screen printing method. The method permits the production of back-injected films with a front face (1a) which is structured or at least appears to be.

The invention relates to a method for production of an object with a first layer, which is bonded to a second layer, the first layer being plastically deformable and having a front side and a rear side, and the bonding of the two layers taking place in an injection mold.

In-mold lamination of films by the injection-molding process has long been known in the prior art. This involves inserting a film, for example a metal foil, into an injection mold and injecting thermoplastic material behind it. It is also known to provide the front side of the film with depressions, these depressions forming for example an inscription or a pattern. For this purpose, the injection mold is structured on the inside in a way corresponding to the depressions to be produced on the film. During the in-mold lamination, the film is pressed against the structured inner side of the injection mold. Such a process is known for example for the production of inserts in sill trim moldings. These inserts are consequently respectively provided on their front side with depressions which give an optical effect of depth. The depressions form an inscription for example. This method makes it possible for such objects to be mass produced comparatively inexpensively.

The invention is based on the object of providing a method of the stated type which offers further possibilities for the design of the objects and which is nevertheless suitable for automated mass production. It is consequently intended to be possible with the method that the front side of the object can be designed with the greatest possible diversity and in an esthetically attractive manner.

In the case of the method according to the invention, the first layer is partially provided with a coating on its front side. This coating is subsequently cured. The first layer with the cured coating is introduced into an injection mold. In this injection mold, plastic is for example injected behind the first layer, this layer being pressed with its front side against an inner side of the injection mold. The cured coating thereby changes the form of the first layer and creates an impression in it. The pressing of the coating into the first layer preferably takes place in such a way that a depression is formed in it. The laminated layer is finally demolded. The choice of the coating allows a front side which is textured to be produced and/or for example the choice of a colored coating allows it to be made of any color desired.

The coating is preferably pressed completely into the first layer. If, according to a development of the invention, the coating is produced from a transparent ink, a special optical effect is obtained. In particular, this allows a particularly interesting effect of depth to be achieved. As a result, the flanks of the depressions become visible.

According to a development of the invention, the coating is produced by a printing ink. This preferably takes place by means of screen printing or pad printing. This allows different patterns or inscriptions to be applied in a simple way. The curing of the printing ink preferably takes place thermally, by UV radiation or by exposure to air. Curing by a chemical reaction, or by a combination of various processes, is also conceivable.

According to a development of the invention, the first layer is an aluminum foil or steel foil. Foils made for example of copper, brass or other suitable metals are also conceivable, however. During the in-mold lamination, these foils are deformed by the cured coating and, in the case of the injection-molding, are substantially impressed by the coating. As a result, very exact patterns and inscriptions which can give a special optical effect can be produced. The surface can in fact be made multicolored as desired. What is important is that the stated method steps can be automated. The method is consequently also suitable for mass production with large numbers of items.

The invention also relates to an object produced by the stated method. The object is characterized in that the front side of the first layer partially has depressions which are deformations of a coating. The coating is preferably a printing ink. This is preferably arranged such that it is recessed in the first layer. According to a development of the invention, the coating is a semi-transparent or transparent printing ink. This allows a particularly interesting effect of depth to be achieved.

According to a preferred configuration, the object is a decorative part, in particular a trim molding for a motor vehicle. Such trim can be produced by the method according to the invention particularly inexpensively and in large numbers of items. Nevertheless, the sill trim molding is durable and, as mentioned above, can be formed with a special front side.

Further advantageous features emerge from the dependent patent claims, the description which follows and the drawing.

Exemplary embodiments of the invention are explained in more detail below on the basis of the drawing, in which:

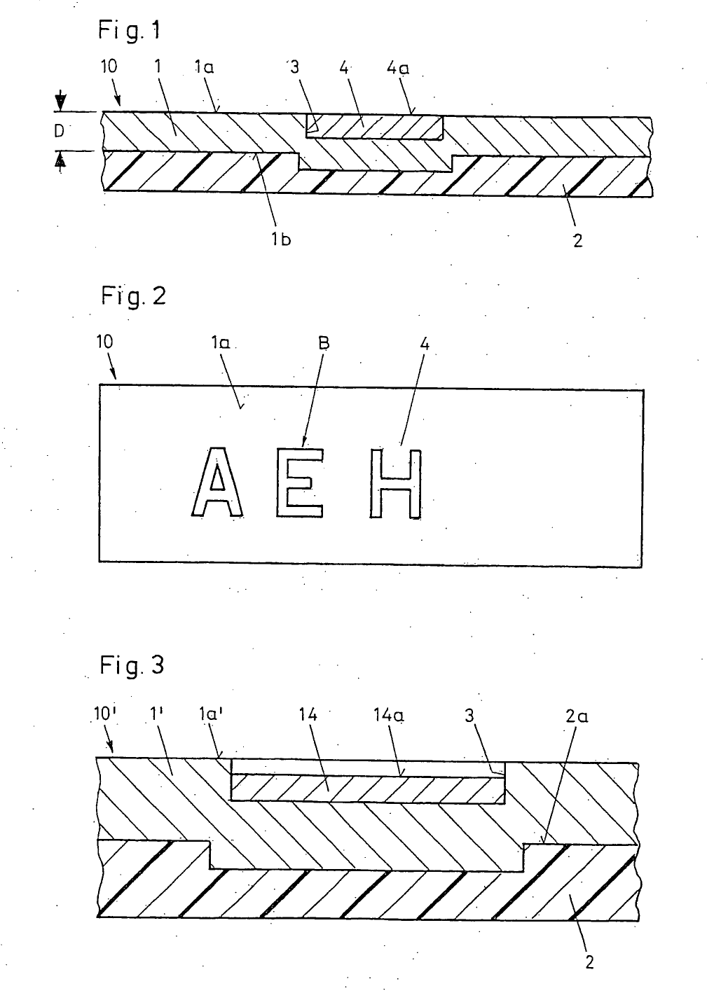

FIG. 1 shows a section through part of an object according to the invention,

FIG. 2 shows a view of an object according to the invention,

FIG. 3 shows a section through a portion of an object according to the invention according to one variant, and

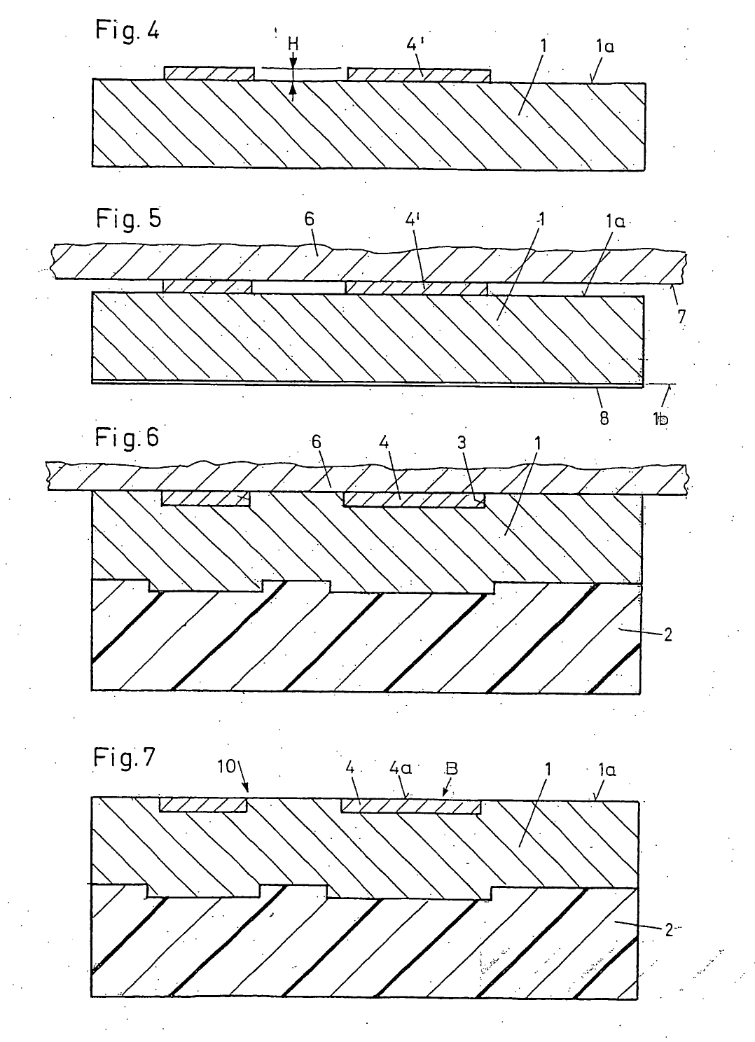

FIGS. 4 to 7 schematically show individual steps of the method according to the invention.

FIGS. 1 and 2 show a sill trim molding 10, which has a first layer 1 with a front side 1a and a rear side 1b and also a laminated-on second layer 2. The first layer 1 is preferably an aluminum foil or steel foil. The foil 1 may, however, also be made of some other suitable plastically deformable material, in particular metal. The layer 1 may also be a composite of more than one layer, for example a metal layer and a varnish layer. For example, the foil 1 may also be made of copper or brass. The thickness D of the first layer 1 is preferably less than approximately 0.5 mm. The thickness preferably lies in the range from 0.1 to 0.3 mm. The second layer consists of a plastic, in particular a thermoplastic, which is laminated onto the rear side 1b of the first layer 1 by the injection-molding process. For better adhesion of the second layer 2, on the rear side 1b is provided with an adhesion promoter 8 known per se before the in-mold lamination.

According to FIG. 2, a representation B, which is for example an inscription or any desired pattern, is visible on the front side 1a. The representation B only extends over a partial region of the front side 1a. It is formed by a coating 4, which is arranged in a depression 3 of the first layer 1. As FIG. 1 shows, an upper side 4a of the coating 4 is in the plane of the front side 1a. This is not absolutely necessary, however, as the exemplary embodiment 10′ according to FIG. 3 shows. In the case of this embodiment, a coating 14 has an upper side 14a, which is located below the front side 1a′ of a first layer 1′. In principle, the upper side 14a could also be arranged above the front side 1a′. Moreover, it is conceivable in principle for the coating 4 or 14 to comprise more than one layer.

The method for production of an object 10 is explained in more detail on the basis of FIGS. 4 to 7.

Firstly, a first layer 1, for example an aluminum foil, is cut into the intended shape, which however is not absolutely necessary, and is partially provided on its front side 1a with a coating 4′ of the thickness H. The coating 4′ is applied for example by printing with a printing ink. The printing may also be multicolored. This may take place for example by screen printing or pad printing. The coating 41 may in fact be any desired representation B, for example an inscription or a pattern, as is represented for example in FIG. 2. The height H of the coating 4′ above the upper side 1a lies in the range from 2 to 1000 micrometers, preferably in the range from 2 to 100 micrometers. A particularly preferred height H is approximately 4 to 10 micrometers.

After the coating 4′ is applied, it is cured. This may take place for example thermally, with UV radiation or by exposure to air. The curing takes place for example at approximately 100° C., this temperature of course being dependent on the type of coating 4′.

After the curing, the first layer 1 is inserted into the injection mold 6. This preferably takes place automatically in a way known per se. The injection mold 6 has an inner side 7, which is preferably planar or convex and on which the first layer 1 is to be placed with its front side 1a. After closing of the injection mold 6, a layer 2 is laminated behind the first layer 1. In order to improve the adhesion of the in-mold laminated second layer 2, an adhesion promoter 8 is preferably applied to the rear side 1b of the first layer 1 according to FIG. 5. Adhesion promoters 8, which improve the adhesion of plastic on metal, for example aluminum, are known per se to a person skilled in the art. While the plastic is being injected behind the first layer 1, the latter is pressed with its front side 1a against the inner side 7 of the injection mold 6 with comparatively high pressure and within a very short time interval. The pressure is, for example, 600 bar. When the first layer is pressed against the inner side 7, the coating 4′ forms an impression in the first layer 1. The impressing or deforming of the first layer 1 causes corresponding depressions 3, which are formed in a way corresponding to the coating 4′, to be created in the first layer 1. Tests have surprisingly shown that the depressions 3 are comparatively sharp-edged; the depressions 3 consequently correspond to the coating 4′. After the in-mold lamination with a coating 4, the depressions 3 are filled, which however is not absolutely necessary. During the pressing-in, the coating 4′ is deformed only insignificantly. The layer 1 is made to project on its rear side, as can be seen for example in FIG. 1.

After the in-mold lamination, cooling and deforming are performed in a way known per se. The object 10 shown in FIG. 7 is then obtained. This comprises a composite of the first layer 1 and the second layer 2, which are firmly bonded to each other. The upper side 1a is provided with an image or some other representation, which is formed by the coating 4 pressed into the first layer 1. In the case of this exemplary embodiment, the outer side 4a is flush with the front side 14a. A protective layer, for example a varnish, may be applied to the front side 1a, and may also cover the front side 4a of the coating 4. The front side 14a may, however, also be protruding or recessed, as FIG. 3 shows. In order to produce the object according to FIG. 3, the coating 14 is formed with more than one layer. An outer layer is removed after the in-mold lamination, for example dissolved by means of a solvent. In principle, the entire coating 4 or 14 may also be removed, in particular dissolved from the depression 3 or 3′. In this case, the front side 1a or 1a′ is textured with depressions 3 and 3′, respectively. A configuration in which some of the depressions are empty and some others are filled with a coating 4 or 14 is also conceivable.

The coating 4 or 14 may be transparent or translucent, semi-transparent or opaque. A front side 1a or 1a′ which visually appears as a textured surface with an effect of depth is obtained in this way. Since the coating 4 or 4′ may be multicolored, there are numerous possibilities for the design of the front side 1a. Since the printing of an upper side and the in-mold lamination by the injection-molding process are inexpensive and can be automated, mass production of large numbers of items is also possible.

The object 10 is, in particular, a decorative part, in particular a trim molding for a passenger vehicle. The object 10 or 10′ may, however, also be some other article, for example a covering plate, a door plate, a housing of a device, for example of a sanitary fitting, a connecting part, a covering strip, etc. The object 10 or 10′ is generally two-dimensional, but this is not absolutely necessary.

1. A method for production of an object (10, 10′) with a first layer (1), which is bonded to a second layer (2), the first layer being plastically deformable and having a front side (1a) and a rear side (1b), and the bonding of the two first layer (1, 2) taking place in an injection mold, characterized by the following method steps:
a) the first layer (1) is partially provided with a coating (4′) on its front side (1a),
b) the coating (4′) is cured,
c) the first layer (1) is inserted into an injection mold (6),
d) the first layer (1) is pressed with its front side (1a) against an inner side (7) of the injection mold (6), the cured coating (4′) changing the form of the first layer (1) and at least partially creating an impression in the first layer (1),
e) the product (10, id) is demolded.

2. The method as claimed in claim 1, characterized in that the coating (4′) is impressed substantially completely into the first layer (1) and forms one or more depressions (3) in the latter (4′).

3. The method as claimed in claim 1 or 2, characterized in that the first layer (1) is laminated in the injection mold (6) by injecting plastic behind it and the second layer (2) is thereby formed.

4. The method as claimed in one of claims 1 to 3, characterized in that a thermoplastic is injected behind the first layer (1).

5. The method as claimed in one of claims 1 to 4, characterized in that the first layer (1) is provided with an adhesion promoter (8) on its rear side (1b) before the in-mold lamination.

6. The method as claimed in one of claims 1 to 5, characterized in that the first layer (1) is a metal foil, in particular an aluminum foil or steel foil.

7. The method as claimed in one of claims 1 to 7, characterized in that the thickness (D) of the first layer (1) is 0.5 mm or less, preferably 0.1 mm or less.

8. The method as claimed in one of claims 1 to 6, characterized in that the thickness (D) of the first layer (1) is 0.1 to 0.3 mm.

9. The method as claimed in one of claims 1 to 8, characterized in that the coating (4′) has a thickness (H) of from 2 to 1000 micrometers, preferably 2 to 100 micrometers.

10. The method as claimed in one of claims 1 to 9, characterized in that the thickness (H) of the coating (4′) is 4 to 10 micrometers.

11. The method as claimed in one of claims 1 to 10, characterized in that the coating (4′) is an imprint.

12. The method as claimed in one of claims 1 to 11, characterized in that the coating (4′) is produced from one or more printing inks.

13. The method as claimed in claim 12, characterized in that the printing ink is at least partially translucent, transparent or semi-transparent.

14. The method as claimed in one of claims 1 to 13, characterized in that the coating (4′) is applied by screen printing or pad printing.

15. The method as claimed in one of claims 1 to 14, characterized in that the coating (4′) is cured thermally, with UV radiation, chemically or by exposure to air.

16. The method as claimed in claim 15, characterized in that the imprint (4′) is cured at 70 to 100° C., preferably approximately 800.

17. The method as claimed in one of claims 1 to 16, characterized in that the coating (4′) comprises more than one layer.

18. The method as claimed in one of claims 1 to 18, characterized in that the coating (4) is at least partially removed, preferably dissolved away or pulled off.

19. The method as claimed in one of claims 1 to 18, characterized in that a decorative part or a trim molding for a motor vehicle is produced.

20. An object, produced by the method as claimed in claim 1, characterized in that the front side (1a) of the first layer (1) partially has a depression or depressions (3), which are deformations and in particular impressions created by a partial coating (4).

21. The object as claimed in claim 20, characterized in that the depression or depressions (3) are completely or partially filled with a printing ink.

22. The object as claimed in claim 20 or 21, characterized in that the coating (4) has an upper side (4a) which is arranged deeper than the front side (1a) of the first layer (1).

23. The object as claimed in one of claims 20 to 22, characterized in that the coating (4) is transparent or opaque.

24. The object as claimed in one of claims 20 to 23, characterized in that the coating (4) is a printing ink.

25. The object as claimed in one of claims 20 to 24, characterized in that the first layer (1) is a metal foil and has a thickness (D) which is less than 0.5 mm, preferably 0.1 to 0.3 mm.

26. The object as claimed in one of claims 20 to 25, characterized in that it is a decorative part or a trim molding for a motor vehicle.

27. The object as claimed in one of claims 20 to 26, characterized in that the second layer (2) is an injection-molded part.
